(19) United States
(12) Patent Application Publication
(10) Pub. No.: US 2016/0017164 A1
(43) Pub. Date: Jan. 21, 2016

(54) SOLID DISPERSION OF A PIGMENT IN THE GRANULAR FORM AND THE RELATIVE PREPARATION PROCESS

(71) Applicant: NOVACHEM INDUSTRIALE S.R.L., Legnano (MI) (IT)

(72) Inventor: Matteo QUETTI, Legnano (IT)

(73) Assignee: NOVACHEM INDUSTRIALE S.r.l., Legnano (MI) (IT)

(21) Appl. No.: 14/773,008

(22) PCT Filed: Mar. 12, 2014
(86) PCT No.: PCT/IB2014/059669

§ 371 Date: Sep. 4, 2015

(30) Foreign Application Priority Data
Mar. 18, 2013 (IT) MI2013A 000408

(51) Int. Cl. C09D 17/00; C08K 5/3495; C09D 103/02

(52) U.S. Cl. CPC C09D 17/003; C09D 103/02; C08K 5/3495

(57) ABSTRACT

A solid dispersion of pigment in granular form may include: at least one pigment; and at least one cold-water-soluble modified starch. A method for preparing an aqueous composition including at least one pigment may include: combining the at least one pigment, at least one cold-water-soluble modified starch, and water. A process for preparing a solid dispersion of pigment in granular form may include: mixing at least one pigment, at least one cold-water-soluble modified starch, and water to form a paste; and/or grinding the paste and evaporating at least part of the water to obtain the solid dispersion. A process for using at least one cold-water-soluble modified starch may include: preparing a solid dispersion of pigment in granular form by combining at least one pigment, the at least one cold-water-soluble modified starch, and water; and/or using the at least one cold-water-soluble modified starch as a carrier agent in the solid dispersion.

The present invention concerns a solid dispersion of a pigment in the granular form and the relative preparation process. The solid granular dispersion of the present invention is suitable for colouring aqueous compositions.

As it is known, pigments are solid particles that are substantially insoluble in the liquid and in the resin or the polymer of the system in which they are incorporated so as to give it colour.

The use of suitably wet and ground pigments makes it possible to increase the effectiveness of the colouring process (colour rendering), with respect for example to the use of the pigment in the form of a dried powder. The latter, indeed, generally contains a fraction of powders in the aggregate form and for such a reason it is also more difficult to disperse it homogeneously in the liquid phase.

In numerous industrial processes, like for example the processes of producing paints, inks, compositions for functional coatings, etc., the colouring of a liquid phase is generally carried out by incorporating the pigments in the form of dispersions (pre-dispersed pigments). The pigments, that is, are added to the product to be coloured in a concentrated form after being intimately mixed with a suitable carrier agent, with possible wetting agents and/or dispersion agents, with solvents (water or other suitable mobile phase) and are subsequently ground to the desired fineness, so as to form a homogeneous dispersion of the pigments. Such a dispersion can be added to the phase to be coloured in the form of a liquid, a paste or a solid.

The use of pre-dispersed pigments makes it possible to prevent the pigment from being dispersed and then ground in the entire finished product that is desired to be coloured, with obvious savings in terms of time and production costs. Moreover, with the pre-dispersed pigments, for a more efficient grinding, the amount of pigment used in order to obtain a certain colouring effect is smaller (i.e., the colour rendering is higher) with respect to the use of the same pigment dispersed and ground in the entire finished product to be coloured, and even more with respect to the use of the pigment in powder form (not pre-dispersed).

The solid dispersions of pigments are solid compositions in the subdivided form, like granules or chips. The solid dispersions of pigments in the subdivided form are also called “granular dispersions”.

Granular dispersions contain at least one pigment and a carrier agent, and are substantially without a fluid phase, regardless of whether it is made up of solvents, water or others. Typically, the carrier agent is chosen from the thermoplastic resins, such as nitrocellulose resins, vinyl resins or acrylic resins.

The choice of such carriers is based upon the binding power thereof towards the pigments and upon the compatibility and solubility in the system that is desired to be coloured.

The granular dispersions are widely used for dispersing a pre-ground pigment in liquid compositions, which are mainly organic solvent based. These dispersions, in addition to being characterised in that they have a higher colour rendering with respect to the dispersions in the form of a liquid or paste and even more to the dried pigments in powder, can be easily dosed, even automatically, inside an industrial process. In general, the granular dispersions are characterised in that they have high colour rendering, high storing stability, substantial absence of volatile solvents, easy handling and dosing without staining and in that it does not generate packaging to be disposed of as special waste or toxic and dangerous waste.

The granular dispersions intended for colouring aqueous systems known in the state of the art have several drawbacks that as of today have not been solved.

One first drawback is the low dispersion speed of the granule in the aqueous liquid phase, due to the difficult solubilization in water of the vehicles used to this day for producing such dispersions. The dispersion of the pigment in the aqueous liquid phase generally requires an addition to the latter of basifying chemical compounds (e.g. ammonia or ammonia compounds) which, by raising the pH of the liquid phase, promote the solubilization of the resin carrier. The presence of such compounds that modify the pH frequently leads to considerable drawbacks to the water-based system, for example in the case in which this must be dried for the use for which it is intended, through evaporation of the liquid phase (in this case water).

In order to promote the dispersion of the pigment it is also useful to heat the liquid composition to which the granular dispersion is added. The heat treatment, however, in addition to increasing the consumption of energy of the process, it is not always compatible with the chemical nature of the liquid composition to be coloured. Moreover, even if both the aforementioned provisions are used (addition of basifying compounds and heating of the water-based composition), the dispersion time and/or solubilization time of the granule remain quite high.

A further drawback of the granular dispersions known in the state of the art pertains to the fact that their components, in particular the resins used as carrier agents, are often incompatible with the use in the production cycles of food products, cosmetic products, pharmaceutical products and the like, wherein the substances that can be used are regulated by strict standards for protecting the environment and human health. This, of course, greatly restricts the field of application of the granular dispersions of pigments of the prior art.

In addition to the granular dispersions in which the carrier agent is a thermoplastic resin, from WO 2012/051406 granular dispersions are known in which the carrier agent is made up of a surface active agent, for example an alcohol ethoxylate. The granular dispersions are prepared by adding the pigment in powder form to the surface active agent, after having heated the latter at a temperature that is greater than its melting point. The surface active agent-pigment mixture is then cooled down to room temperature and is ground. The granular dispersions described in WO 2012/051406 can contain, moreover, polyvinyl alcohol, polyvinylpyrrolidone, polyethylene glycol and starches. Such granular dispersions, in any case, require an increase in the temperature of the aqueous system in order to be solubilized in times that are still long but acceptable.

Patent GB 871180 describes the use of a modified starch (methyl-starch) that is soluble in water at low temperatures for treating dispersions of pigments in the form of a presscake. The presscake is the wet solid fraction that separates through filtering (generally through filter-pressing) from the aqueous dispersions containing the pigment (slurry) obtained at the end of the wet industrial production processes of the pigments. In accordance with the process described in GB 871180, the presscake containing the pigment dispersed in water is subsequently added with an aqueous solution of modified starch, with low viscosity; the mixture thus obtained is then heated until the pigment is made flocculating and finally filtered, so as to separate a presscake in which the pigment concentration is higher with respect to that of the starting presscake, but always with a high water content.

The purpose of the present invention is to avoid the drawbacks of the granular dispersions of pigment known in the state of the art.

In such a general purpose, one purpose of the present invention is to provide a granular dispersion that makes it possible to effectively and quickly disperse a pigment in a liquid composition, in particular an aqueous composition, without needing the addition of basifying additives or the use of mechanical homogenizations systems with high energy.

Another purpose of the present invention is to provide a granular dispersion with chemical characteristics such as to be able to be used in various fields of application, including the preparation of food products, cosmetic products, pharmaceutical products and the like.

Another purpose of the present invention is to provide a preparation process of a granular dispersion of pigments that is cost-effective and easy to make.

These and other purposes are achieved with the solid dispersion of a pigment in the granular form according to the present invention, which comprises at least one pigment and at least one cold water-soluble modified starch.

According to another aspect, the present invention concerns a process for,preparing a solid dispersion of a pigment in the granular form, which comprises at least the steps of:
mixing at least one pigment, at least one cold water-soluble modified starch and water, in addition to possible additives (for example, wetting and/or dispersion adjuvants), until a paste is formed;
grinding said paste and evaporating at least one part of said water, so as to obtain a solid dispersion of said pigment.

According to another aspect, the present invention concerns a pigment paste comprising the aforementioned solid dispersion of pigments in the granular form.

According to another aspect, the present invention concerns the use of the aforementioned solid dispersion of pigments in the granular form for preparing an aqueous liquid composition comprising at least one pigment.

According to another aspect, the present invention concerns the use of a cold water-soluble modified starch as a carrier agent in a solid dispersion of a pigment in the granular form.

The solid dispersion of a pigment according to the present invention is a solid composition in the granular form. For the purposes of the present invention, by the term “granular” it is meant that the dispersion is in the subdivided form, for example in the form of particles (powder), granules or flakes.

The granular dispersion object of the present invention comprises one or more pigments and at least one carrier agent comprising a cold water-soluble modified starch.

For the purposes of the present invention by the term “pigment” it is meant a solid that is black, white or has another colour, or is fluorescent, which is capable of altering the optical appearance of the means in which it is incorporated upon the interaction with electromagnetic radiations (for example light absorption, diffusion or dispersion). The pigment is substantially insoluble in the means in which it is incorporated and does not undergo substantial, physical or chemical modifications due to said means.

The pigments that can be used for the purposes of the present invention comprise organic and inorganic pigments, both natural and synthetic.

Examples of inorganic pigments include oxides, hydroxides and salts of elements that may or may not be of the metal kind, like for example oxides, hydroxides or Fe, Ti, Zn, Ce, Mn salts.

Examples of organic pigments include azoic pigments, phthalocyanine pigments and quinacridone pigments.

The overall amount of pigment present in the granular dispersion is preferably comprised in the range 50%-90% by weight with respect to the weight of the granular dispersion, more preferably in the range 65%-86%, even more preferably in the range 70%-82% (percentages referring to the weight of the dry granular dispersion after drying at 120° C. for 180 minutes).

In accordance with the present invention, the granular dispersion comprises at least one cold water-soluble modified starch that acts as a carrier agent of the pigment. Moreover, since it is solid, the starch promotes grinding operations (crushing of the coarser aggregates and the micronization of the granules with smaller dimensions) possibly carried out on the granular dispersion obtained with the process of the present invention. Said starch can be obtained substantially by any known source of starch, like for example wheat, corn, rice, potato and manioc.

The starch used in the granular dispersion as a carrier agent of the pigment is a modified starch, so as to be soluble in cold water. For the purposes of the present invention, by “starch soluble in cold water” (hereafter also “soluble starch”) it is meant a starch that, if added to the water at room temperature (around, 25° C.), loses its granular form in a substantially complete manner, forming an aqueous solution or colloidal dispersion.

Preferably, the cold water-soluble modified starch has the aforementioned behaviour in water having a temperature of below 25° C., preferably comprised between 10° C. and 25° C.

As known by a person skilled in the,art, a natural starch (native starch) can be made soluble in cold water by subjecting it to physical, chemical or enzyme type treatments.

The soluble starch, for example, can be prepared by subjecting an aqueous dispersion of a natural starch, simultaneously, to a cooking treatment and a spray drying treatment. A preparation process of soluble starches is described for example in U.S. Pat. No. 5,149,799. Other preparation processes known to the person skilled in the art are those based on extrusion or cooking and spray drying processes that can be carried out in drum dryers.

One example of chemically modified starches is represented by the starches replaced with acetate groups which can be obtained, for example, through esterification reactions with acetic anhydride.

In one preferred embodiment, the starch used for preparing the granular dispersions of the present invention is potato starch, since it forms aqueous dispersions with lower viscosity with respect to other types of starch. In particular, with potato starch having fine granulometry it is possible to prepare dispersions of pigments that are capable of being dispersed or dissolved in an aqueous composition very quickly.

In an alternative embodiment, the starch is preferably chosen from corn starch, rice starch and mixtures thereof.

The amount of starch present in the granular dispersion is preferably comprised in the range 2%-50% by weight with respect to the weight of the granular dispersion, more preferably in the range 3%-30%, even more preferably in the range 5%-20% (percentages referring to the weight of the dry granular dispersion after drying at 120° C. for 180 minutes).

The granular dispersions can also comprise additives, such as for example, wetting compounds (e.g. surface active agents) and dispersion compounds. For such a purpose the Applicant has found it particularly useful to use ethylene glycols as wetting compounds in preparing the granular dispersions, except for in edible granular dispersions. The ethylene glycols include the mono-, di-, tri-ethylene glycols or higher homologues. Among the aforementioned ethylene glycols, diethylene glycol (DEG) is particularly preferred for its effectiveness, availability and convenience. DEG behaves like an oil phase, wetting the pigment very effectively. Moreover, since it can be mixed with water in all ratios, it acts as an effective interface between the aqueous phase and the pigment once the granular predispersion has been brought to the liquid or paste form.

The aforementioned additives can be added to the Mixture in different amounts. For example, they can be present in amounts comprised in the range 1%-25% by weight, preferably in the range of 2%-20%, more preferably in the range of 5%-15% (percentages referring to the weight of the dry granular dispersion after drying at 120° C. for 180 minutes).

The granular dispersions according to the present invention are prepared by mixing together at least one pigment, at least one soluble starch and water.

The water mixed with the other ingredients is in an amount such as to obtain a paste (or mixture) that has a viscosity that is suitable for undergoing grinding. For such a purpose it is possible to use, for example, a cylinder grinder or other device of the type that is generally used for grinding pigments.

The amount of water used varies mainly as a function of the type of pigment used, in particular of its capability of absorbing water.

The amount of water used for preparing the mixture, for example, can be selected in the range of 8%-60% by weight with respect to the overall weight of the mixture. Preferably, the amount of water is selected in the range of 10%-40% by weight.

Also the ratio between the amount of starch and the amount of water used in the mixture varies according to the type of pigment used. For example, the starch/water ratio can vary in the range of 1:7-1:1.5, preferably in the range of 1:5-1:2.

In preparing the mixture, the components can be added in any order. Preferably, the pigment and the soluble starch are added to the mix water in powder form.

The mixture comprising the pigment, the soluble starch, the water and the possible additives undergoes grinding.

Preferably, the mixture is initially ground at room temperature and, then, progressively heated so as to maintain, in any case, an amount of water inside the mixture so as to make the grinding as simple and effective as possible and therefore the achievement of the desired level of grinding of the pigment (generally smaller than 15 micron). Once the desired granulometry is obtained, the grinding continues and further heat is provided to the mixture so as to substantially move away the residue water still present, thus obtaining a product in the compact form (sheets). This grinding step mainly has the purpose of producing a solid dispersion in which the pigment has the desired fineness for the application for which it is intended; indeed, the colour rendering of the granular dispersion also at least partially depends upon the fineness of the pigment.

The grinding of the mixture can be carried out with the devices known by a person skilled in the art, like for example, a twin cylinder grinder (mill) equipped with a system for controlling the temperature of the cylinders. This type of grinder makes it possible to adjust the temperature at which the grinding is carried out, heating or cooling the grinding cylinders as a function of the characteristics of the mixture or of the characteristics desired for the final product. Generally, the grinding is initially carried out at room temperature and then by heating the cylinders up to a temperature of 50° C. When the desired fineness of the grinding of the pigment is almost reached, the mixture is further heated so as to evaporate most of the water contained in order to obtain the predispersed pigment in the compact form.

Preferably, the dispersion of pigment in the compact form that is obtained at the end of the grinding is subject to drying, so as to reduce its content of water (residual humidity) to a value that is below 2.5% by weight. The drying can be carried out, for example, by heating the dispersion in an oven to at least 85° C., preferably to at least 110° C., for a time that is long enough to obtain the aforementioned residual humidity value.

After drying, the dispersion preferably undergoes a further grinding step, so as to crush possible agglomerates that are still present and micronize the entire product. This further grinding is carried out to obtain a solid dispersion of the pigment having the optimal granulometry for the use for which it is intended, as well as to obtain a dispersion with a homogeneous granulometry.

The granulometry of the end product is chosen as a function of the use for which the granular dispersion is intended, bearing in mind that the smaller the average diameter of the granules is, the faster the dispersion of the pigment in the aqueous composition is, and that a granulometry that is too fine can lead to problems of dust emission into the work environment during the productive process in which the dispersion is used.

The particles or granules of the granular dispersion preferably have an average diameter that is equal to or greater than 0.1 mm. More preferably, the average diameter of the granules ranges between 0.2 mm and 4 mm and even more preferably between 0.5 mm and 1 mm.

The Applicant has found that the granules having an average diameter of between 0.5 and 2 mm allow the pigment to be dispersed in an aqueous composition at an acceptable speed for the majority of industrial colouring processes, while suitably limiting the dust emission.

The dispersions of pigments according to the present invention can be used to add a pigment in water-based liquid compositions.

Thanks to the choice of cold water-soluble modified starch as a carrier agent, the use of the granular dispersions object of the present invention is particularly advantageous in the case in which aqueous compositions are coloured.

When added to an aqueous liquid phase, indeed, the granular dispersions according to the present invention disaggregate rapidly—facilitated in this by the swelling effect that the modified starch has when it is placed in contact with water thus making the penetration of water itself inside the granule much faster—allowing the dispersion of the pigment in the liquid and the consequent colouring of the aqueous composition. The solubilization of the starch is rapid and does not require the addition of basifying compounds.

The granular dispersion according to the present invention can be used to incorporate a pigment in an aqueous composition even in the form of a pigment paste.

For such a purpose, the granular dispersion is mixed with water, in a ratio by weight such as to generate a paste having the desired viscosity, selected as a function of the specific use for which the pigment is intended. The pigment paste thus obtained is subsequently added to the liquid composition that is desired to be coloured. The pigment paste can also comprise other components that must be incorporated in the liquid composition to be coloured.

The dispersions of pigments according to the present invention can be used to incorporate pigments in water-based liquid compositions, used in a multitude of production processes. In particular, the dispersions according to the present invention can be used to colour a wide range of products, such as inks, coating compositions (e.g. paints, enamels), resins for the textile and leather field, food products, cosmetic products, pharmaceutical products, etc. For example, by using the pigments that are suitable for use in food products (e.g. food colouring) it is possible to prepare edible food dye.

With the dispersions of pigments according to the present invention it is possible to incorporate a pigment in a liquid composition, in particular an aqueous composition, in a manner that is rapid, simple and that has high colour rendering, without needing to use basifying agents or homogenising systems having high power consumption.

The dispersions according to the invention, moreover, since they use starch (i.e. an edible compound) as a carrier agent, they can be used for preparing coloured liquid compositions also in the food, pharmaceutical and cosmetic sectors; this considerably increases the variety of possible uses of the solid dispersions in the granular form with respect to the granular dispersions of the state of the art.

The dispersions of pigments of the present invention, moreover, are also characterised by their versatility of use, since they can be used both in the granular form and in the form of pigment pastes, the viscosity of which can be selected based upon the requirements of the user.

The dispersions of pigments according to the present invention, moreover, can be prepared in a manner that is cost-effective, simple and using conventional apparatuses.

The following embodiment is provided purely for the purposes of illustrating the present invention and must not be taken to limit the protection defined by the attached claims in any way.

### EXAMPLE

A solid granular dispersion according to the present invention was prepared starting from a mixture having the following composition (percentages by weight):

| | Amount |
|---|---|
| Ingredients | (percentage by weight) |
| blue b-phthalocyanine | 63 |
| (Colour Index -C.I.- 15:3) | |
| Potato starch* | 7 |
| Acrylate copolymer 40% in | 11 |
| water (BYK 2012) | |
| DEG | 6.5 |
| water | 12.5 |

*potato starch soluble in cold water in powder (6% by weight of residual humidity)

The mixture was ground in a twin cylinder grinder until a homogeneous dispersion is obtained made up of substantially dry compact sheets.

The sheets were recovered, dried in the oven (120° C., 60 minutes), crushed and then sifted in a micronizer until a homogeneous granular dispersion was obtained with granules having an average diameter that is smaller than 1 mm.

The granular dispersion was incorporated as such at room temperature (20° C.) in a first aliquot part (V1) of a water-based acrylic-polyurethane paint through a conventional disperser equipped with a screw impeller, so as to obtain an enamel for metals.

Thanks to the use of the soluble starch as a carrier agent, the pigment was dispersed inside the paint in a few seconds, giving it a bright and homogeneous colour.

In comparison, the same amount of the same pigment was added to a second aliquot part (V2) of the same paint in the form of a water-based pigment paste of the conventional type and available on the market. This kind of paste is obtained by grinding the pigment directly in the base paste. The comparative test was carried out through cutting of the two paints with a white pigment. For such a purpose, the same amount of white paste pigment (titanium oxide based) was added to the two aliquots in amounts such as to have a blue pigment weight/white pigment weight ratio equal to 1:7. The two cut paints thus obtained were spread at a thickness of 200 micron on Morest paper and oven dried. The paint V1 that was coloured with the granular dispersion according to the present invention had a more intense blue colour. The paint V1 was thus further cut with further amounts of the same white pigment paste until the same colour intensity of the paint V2 was obtained.

Based upon the ratio between the amount of white paste used in the paint V1 and the paint V2 it was concluded that the granular dispersion according to the present invention showed a colour rendering that was greater by 22% with respect to the comparative pigment paste, in addition to greater gloss and colour cleanliness.

1. A solid dispersion of pigment in granular form comprising:
at least one pigment; and
at least one cold-water-soluble modified starch.

2. The dispersion of claim 1, wherein the at least one cold-water-soluble modified starch comprises corn starch, potato starch, wheat starch, manioc starch, rice starch, or mixtures thereof.

3. The dispersion of claim 1, wherein the at least one cold-water-soluble modified starch comprises potato starch.

4. The dispersion of claim 1, wherein the at least one pigment is present in a quantity greater than or equal to 50% by weight with respect to a total weight of the dispersion and less than or equal to 90% by weight with respect to the total weight of the dispersion.

5. The dispersion of claim 1, wherein the at least one cold-water-soluble modified starch is present in a quantity greater than or equal to 2% by weight with respect to a total weight of the dispersion and less than or equal to 50% by weight with respect to the total weight of the dispersion.

6. The dispersion of claim 1, wherein granules of the granular form have an average diameter greater than or equal to 0.1 millimeters (mm).

7. The dispersion of claim 1, further comprising one or more ethylene glycols chosen from mono-ethylene glycol, di-ethylene glycol, tri-ethylene glycol, and higher homologues.

8. A pigment paste, comprising:
at least one solid dispersion of pigment in granular form according to claim 1.

9. A process for preparing a solid dispersion of pigment in granular form according to claim 1, the process comprising:
mixing the at least one pigment, the at least one cold-water-soluble modified starch, and water to form a paste; and
grinding the paste and evaporating at least part of the water to obtain the solid dispersion of pigment in granular form.

10. The process of claim 9, further comprising:
drying the solid dispersion; and
subjecting the solid dispersion to further grinding until a dispersion in a form of granules is obtained;
wherein the granules have an average diameter greater than or equal to 0.1 millimeters (mm).

11. A method for preparing an aqueous composition comprising at least one pigment, the method comprising:
combining the at least one pigment, at least one cold-water-soluble modified starch, and water.

12. A process for using at least one cold-water-soluble modified starch, the process comprising:
preparing a solid dispersion of pigment in granular form by combining at least one pigment, the at least one cold-water-soluble modified starch, and water; and
using the at least one cold-water-soluble modified starch as a carrier agent in the solid dispersion of pigment in granular form.

13. The dispersion of claim 1, wherein the at least one pigment is present in a quantity greater than or equal to 65% by weight with respect to a total weight of the dispersion and less than or equal to 86% by weight with respect to the total weight of the dispersion.

14. The dispersion of claim 1, wherein the at least one pigment is present in a quantity greater than or equal to 70% by weight with respect to a total weight of the dispersion and less than or equal to 82% by weight with respect to the total weight of the dispersion.

15. The dispersion of claim 1, wherein the at least one cold-water-soluble modified starch is present in a quantity greater than or equal to 3% by weight with respect to a total weight of the dispersion and less than or equal to 30% by weight with respect to the total weight of the dispersion.

16. The dispersion of claim 1, wherein the at least one cold-water-soluble modified starch is present in a quantity greater than or equal to 5% by weight with respect to a total weight of the dispersion and less than or equal to 20% by weight with respect to the total weight of the dispersion.

17. The dispersion of claim 1, wherein granules of the granular form have an average diameter greater than or equal to 0.2 millimeters (mm) and less than or equal to 4 mm.

18. The dispersion of claim 1, wherein granules of the granular form have an average diameter greater than or equal to 0.5 millimeters (mm) and less than or equal to 1 mm.

19. The dispersion of claim 1, further comprising:
di-ethylene glycol (DEG).

20. The process of claim 10, wherein the granules have an average diameter greater than or equal to 0.2 mm and less than or equal to 4 mm.
